(19) United States
(12) Patent Application Publication
(10) Pub. No.: US 2018/0053018 A1
(43) Pub. Date: Feb. 22, 2018

(54) METHODS AND SYSTEMS FOR FACILITATING SECURED ACCESS TO STORAGE DEVICES

(71) Applicant: 18 DEGREES LAB PTE. LTD., Singapore (SG)

(72) Inventors: Krishnamoorthy BASKARAN, Singapore (SG); Sivanesan Kailash PRABHU, Singapore (SG)

(21) Appl. No.: 15/557,512

(22) PCT Filed: May 11, 2016
(86) PCT No.: PCT/SG2016/000005

§ 371 Date: Sep. 12, 2017

(30) Foreign Application Priority Data
Mar. 12, 2015 (SG) 10201501931X
Mar. 12, 2015 (SG) 10201601936S

(51) Int. Cl. G06F 21/78; G06F 21/62; G06F 21/34; H04L 9/08; H04L 9/32; H04L 29/06

(52) U.S. Cl. CPC G06F 21/78; G06F 21/62; G06F 21/34; H04L 63/0442; H04L 9/3226; H04L 63/0838; H04L 9/0866

(57) ABSTRACT

The present disclosure discloses methods and systems for facilitating secured access to storage devices. The method includes receiving a request for access to the storage device, the storage device is associated with an identifier, for example, hardware identifier. Upon receiving, at least one of an encryption key and a decryption key associated with the storage device is identified, the identification is performed based on the identifier. After identification, at least one authentication message is transmitted to at least one user device associated with at least one of the storage device and a user of the storage device. Then, at least one authentication response from the user of the storage device is received. Based on the at least one authentication response, access to the storage device is granted.

### FIELD

The present disclosure generally relates to the field of data storage devices. More particularly, the present disclosures discloses methods and systems for facilitating secured access to storage devices using a two-factor authentication mechanism.

### BACKGROUND

With the advent of many methods of unethical hacking and data theft, protection of sensitive data from unauthorised access has gained importance. Further, the proliferation of storage devices (such as USBs, hard drives, flash drives, etc.) necessitate the use of stringent data protection schemes. There are now multiple schemes that maintain data integrity and security. The most commonly used scheme is authenticating access to data. This is implemented via passwords, CAPTCHAs, security questions, tokens, digital signatures, and the like. However, this scheme is prone to security breach via hacking. Another popular scheme is the use of an encryption algorithm, where data to be protected is first converted to a new form—cipher text—using an encryption key and only then it is stored. Sometimes this scheme is often referred to as scrambling. The encrypted data offers a safety net against potential misuse. To un-scramble the data, a corresponding decryption key is used. A disadvantage of this scheme is that the encryption/decryption key is prone to theft by malwares, key loggers, phishing emails and social engineering attacks.

A more advanced technique for data protection is, Two-Factor Authentication (2FA), for example. A common use case of 2FA is in the Internet banking domain. Every time a user logs into his/her. Internet banking account, his/her password (first factor) is verified. On successful verification, the user is prompted to input a code generated by a token (second factor). This code is received on a separate device, for example, mobile phone, associated with the user. Only after this code is verified, the user will be granted access to his/her bank account. Similar to the Internet banking domain, advanced techniques are required for securing data stored on storage devices, considering the usage of storage devices is increasing day-by-day. In view of this, the present disclosure discloses methods and systems for facilitating secured access to storage devices.

### SUMMARY

In an embodiment, a method of facilitating secured access to a storage device is disclosed. A request for access to the storage device may initially be received. Further, the storage device may be associated with an identifier. Furthermore, at least one of an encryption key and a decryption key associated with the storage device may be identified based on the identifier. Subsequently, at least one authentication message may be transmitted to at least one user device associated with at least one of the storage device and a user of the storage device. Then, at least one authentication response from the user of the storage device may be received. Based on the at least one authentication response, access to the storage device may be granted.

In another embodiment, a server for facilitating secured access to a storage device is disclosed. The storage device may be communicatively coupled to a client computer. Further, the client computer may be communicatively coupled to the server over a network. The server may include a communication interface, a processor and a memory communicatively coupled to the processor. The memory may be configured to store program code which when executed by the processor may cause the server to perform the following. The server may receive a request for access to the storage device. The request may include a hardware identifier associated with the storage device. Based on the request, the server may identify at least one of an encryption key and a decryption key associated with the storage device based on the hardware identifier. Once identified, the server may transmit an authentication message to at least one user device associated with at least one of the storage device and a user of the storage device. Thereafter, the server may receive an authentication response from the user. Based on the authentication response, the server may transmit at least one of the encryption key and the decryption key to at least one of the at least one user device and the client computer.

Further embodiments, features, and advantages, as well as the structure and operation of the various embodiments, are described in detail below with reference to the accompanying drawings.

### BRIEF DESCRIPTION OF DRAWINGS

Embodiments are described with reference to the accompanying drawings. In the drawings, like reference numbers can indicate identical or functionally similar elements.

FIG. 1 is an exemplary environment in which various embodiments of the present disclosure can be practiced;

FIG. 2 illustrates a server for facilitating secured access to a storage device;

FIG. 3A illustrates a storage device registration procedure, according to one embodiment of the disclosure;

FIG. 3B shows a storage device registration procedure, according to another embodiment of the present disclosure;

FIG. 3C shows a key retrieval procedure for a storage device, according to an embodiment;

FIG. 3D shows a key retrieval procedure for the storage device, according to another embodiment; and

FIG. 4 is a method flowchart for facilitating secured access to a storage device, according to an embodiment.

### DETAILED DESCRIPTION

In the disclosure herein, consideration or use of a particular element number in a given FIG. or corresponding descriptive material can encompass the same, an equivalent, or an analogous element number identified in another FIG. or descriptive material corresponding thereto.

In the Detailed Description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic may be described in connection with an embodiment, it may be within the knowledge of one skilled in the art to effect such feature, structure, or characteristic in connection with other embodiments whether or not explicitly described.

The following detailed description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

Overview

Storing data in storage devices like a USB (Universal Serial Bus) flash disk, an internal hard-drive and an external hard-drive, is one of the ways preferred by users these days. Such storage devices can be used to store any data, be it confidential, personal, sensitive, proprietary, private, business or any other type of data related to the user. For example, in corporate scenarios, business users prefer to store business data, while home users may store personal or private data in the storage devices. Considering the data in any form is important for users (be it business users or home users), protecting/securing data stored in such storage devices is very essential.

In view of the above, the present disclosure provides methods and systems for facilitating secured access to storage devices or to data (or encrypted data) stored on such storage devices. In particular, the disclosure provides two layers of protection for securing data. The first layer of protection is provided by using an identifier of the storage device to retrieve encryption/decryption keys for the storage device. For example, the encrypted data can only be decrypted when accessed from the storage device on which it was originally encrypted as the storage device identifier is used to retrieve the encryption/decryption key. The second level of protection (also called as Two-Factor Authentication, i.e., 2FA) is provided by the use of a personal device of the user (also referred to as a user device or mobile device in some implementations). The personal device is a separate device used for authenticating the user to access the storage device. For example, the user accessing the encrypted data requires to have this separate device, which is used to authenticate him, before access to the encrypted data is granted. This is the two-factor authentication step. In this manner, the two-factor authentication adds an additional layer of security for protection of data, thereby preventing the mis-use, modification or unauthorized access of the data stored in the storage device. Few examples of the personal device can include a mobile device, smart phone, PDA (Personal Digital Assistant), a tablet computer, a hardware token or any other similar electronic device, without limiting the scope of the disclosure.

Exemplary Environment

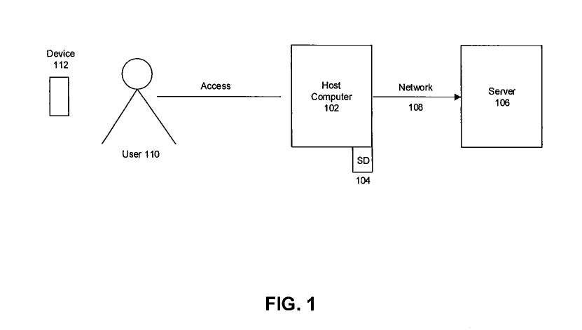

FIG. 1 illustrates an exemplary environment 100 in which various embodiments of the disclosure can be practiced. The environment 100 includes a host computer 102, a storage device 104 communicatively coupled to the host computer 102, a server 106 communicatively coupled to the host computer 102 via a network 108, a user 110, and a personal device 112 (also referred to as user device).

As shown in FIG. 1, the host computer 102 can be any computer, which the user 110 typically uses to perform his daily activities, for example, checking emails, surfing, accessing social networking websites or any related task. The host computer 102′ may be a personal computer, a workstation, a laptop, or any other similar device. In the context of the present disclosure, the host computer 102 is used by the user 110 to access data stored on the storage device 104. To this end, the host computer 102 communicates with the server 106 via the network 108. The network 108 may be any suitable wired, wireless network or any other conventional network, without limiting the scope of the disclosure.

As shown, the storage device 104 can store any data such as sensitive data, confidential, private, personal, business data, or any other type of data. For a person skilled in the art, it is understood that the storage device 104 may store any kind of data, information or details and the above examples are sufficient for understanding purposes, without limiting the scope of the disclosure. The storage device 104 further stores data related to the user in any suitable format, such as, for example, in encrypted form. In other examples, the data may be stored in the storage device 104 in a plain format. The storage device 104 is associated with a unique identifier which may be a serial number and/or a hardware number of the storage device 104. In other implementations, the storage device 104 can have any other identifier, which uniquely identifies the storage device 104.

Further, the storage device 104 can be a removable device; in such cases the storage device 104 can be in the form of an external device such as USB flash disk or external hard drive. While in other implementations, the storage device 104 can be an integral part of the host computer 102, thus may be in the form of an internal hard drive, such as, for example, a Solid State Drive (SSD).

In some implementations, the user 110 can be a corporate user, while in other implementations, the user 110 can be a home user. In cases where the user 110 is a corporate user, the host computer 102 communicates with the server 106 using a corporate network. In cases, the user 110 is a home user or an individual user, the host computer 102 communicates with the server 106 via home network.

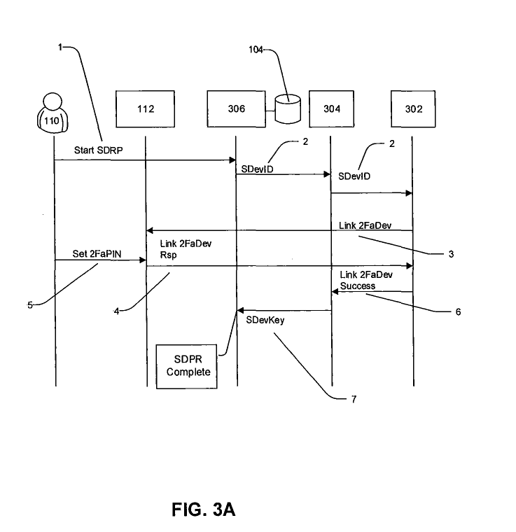

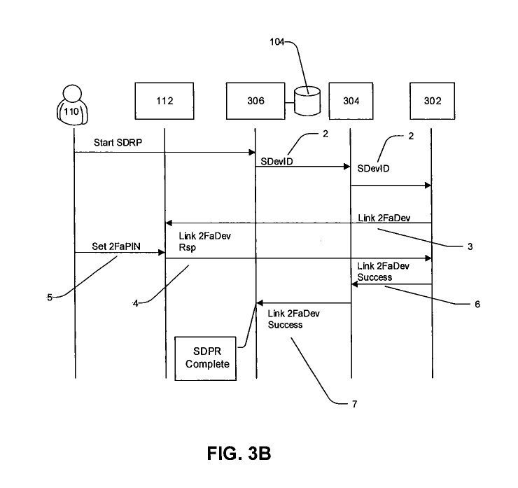

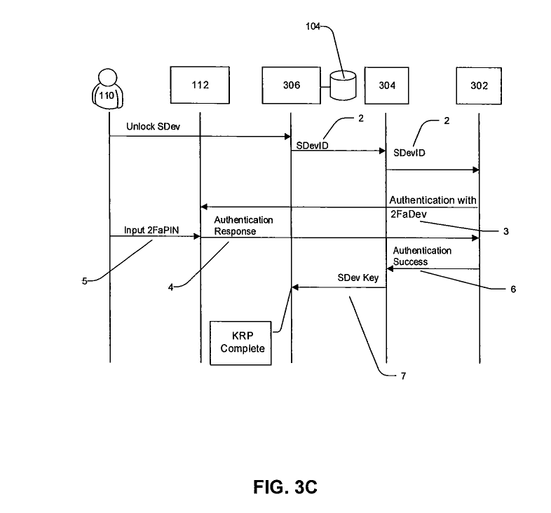

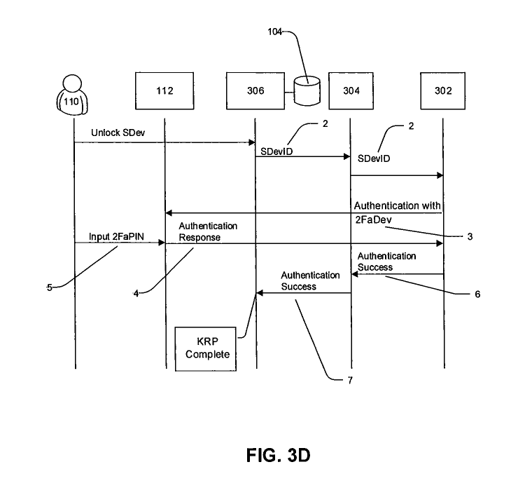

Before accessing any data stored on the storage device 104, the personal device 112 requires to be registered with the server 106, as the second factor authentication is performed with the user's personal device 112 such as a mobile phone. Various other examples of the personal device 112 can include smart phone, PDA (Personal Digital Assistant), a tablet computer, a hardware token or any other similar electronic device. In particular, the registration process requires association of the personal device 112 with the storage device 104, for example, the storage device identifier. While in other embodiments, the personal device 112 may be associated with a user (in this case the user 110) of the storage device 104. For the discussion of FIG. 1, it can be considered that the personal device 112 is already registered for secured access to the storage device 104. The registration process is discussed in detail below with FIGS. 3A-3B.

In the context of the present disclosure, the host computer 102 is used by the user 110 to access the data stored on the storage device 104 and to this end, the user 110 plugs the storage device 104 to the host computer 102. Upon plugging, the request to access the data on the storage device 104 is sent to the server 106. Along with the access request, the identifier is also transmitted to the server 106. Based on the identifier, the server 106 identifies the personal device 112 and/or the user 110 associated with the identifier and transmits an authentication message to the user 110. The authentication message is transmitted to the user 110 on the personal device 112 of the user 110. The personal device 112 is associated/registered with the storage device 104 and/or the user 110 of the storage device 104. Based on the authentication message, the user 110 provides an authentication response to the server 106 via the host computer 102. In other examples, the authentication response may be input by the user 110 using the personal device 112. In such instances, the personal device 112 can be connected to the server 106 via the network 108.

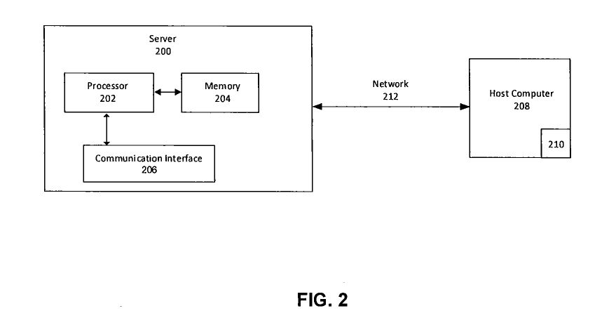

Thereafter, the server 106 checks for the authentication response and authenticates the user 110 to access the data stored on the storage device 104. Accordingly, the server 106 may transmit encryption/decryption key to the host computer 102. In this manner, the user 110 is granted access to the data stored on or within the storage device 104. The access may be in the form of any operation which can be performed by the user 110, for example, read operation, a write operation, a delete operation, an update operation, encryption and decryption, without limiting the scope of the disclosure. More structural details, or implementations/various embodiments will be discussed below in detail in conjunction with FIGS. 2, 3, and 4.

While discussing figures below, references can made to any FIGS. 1-4.

Exemplary Server

FIG. 2 illustrates a server 200 for facilitating secured access to storage devices, according to an embodiment. FIG. 2 is shown to include a server 200 having a processor 202, a memory 204, and communication interface 206 communicatively coupled to the processor 202. The memory 204 is configured to store a program code which when executed by the processor 202 causes the server 200 to perform one or more functionalities or steps that facilitate secured access to a storage device 210. Each of the shown components communicate with each other using conventional bus or suitable protocols.

As shown, the sever 200 is communicatively coupled to a host computer (also known as a client computer) 208 and the server 200 communicates with the host computer 208 using a network 212. The network 212 may be a wired or wireless network or a combination of these. Few examples may include a LAN or wireless LAN connection, an Internet connection, a point-to-point connection, or other network connection and combinations thereof. The network 212 can be any other type of network that is capable of transmitting or receiving data to/from host computers, personal devices, telephones or any other electronic devices. Further, the network 212 is capable of transmitting/sending data between the mentioned devices. Additionally, the network 212 may be a local, regional, or global communication network, for example, an enterprise telecommunication network, the Internet, a global mobile communication network, or any combination of similar networks. The network 212 may be a combination of an enterprise network (or the Internet) and a cellular network, in which case, suitable systems and methods are employed to seamlessly communicate between the two networks. In such cases, a mobile switching gateway may be utilized to communicate with a computer network gateway to pass data between the two networks.

The storage device 210 is communicatively coupled to the host computer 208. The storage device 210 and the host computer 208 are similar to the storage device 104 and host computer 102 respectively, as discussed in FIG. 1. Accordingly, any structural or implementation related details can be referred from description of FIG.

Typically, the server 200 sends and/or receives data to/from the host computer 208 as and when required. In the context of the disclosure, the server 200 communicates with the host computer 208 to facilitate secured access to the storage device 210.

More particularly, the server 200 facilitates two-factor authentication before allowing access to the storage device 210. To re-iterate, the two-factor authentication is a way to provide an extra layer of security to access the storage device 210. Here, the first factor authentication is in the form of encryption/decryption key (obtained based on the identifier of the storage device 210). And, the two-factor authentication can be done using the personal device (see 112 in FIG. 1, although not shown in FIG. 2) of the user 110 (see FIG. 1). The two-factor authentication ensures security, and prevents data breach and loss of credentials.

Further, the server 200 performs one or more functionalities such as generation of encryption/decryption keys, storage of the encryption/decryption keys, performs authentication of the user 110, generates authentication messages, receives corresponding authentication responses and related functionalities.

The encryption/decryption keys can be used to encrypt/decrypt data stored on the storage device 210. In an embodiment, the encryption/decryption keys can be generated based on the identifier of the storage device 210, such as, for example a hardware identifier. The encryption/decryption of the data stored on the storage device 210 may be performed using known or other algorithms such as AES, RC4 encryption algorithms, Triple DES (Data Encryption Standard), RSA, AES (Advanced Encryption Standard) or a combination of these.

In some embodiments, the encryption/decryption keys may be generated each time the storage device 210 is plugged into the host computer 208. In this case, the encryption/decryption keys may be different from the ones generated at the time of registration. While in other implementations, the encryption/decryption keys may be generated at the time of registration and the same encryption/decryption keys may be used further for any operation.

In the context of the disclosure, the server 200 receives a request from the user 110 to access the storage device 210 along with a unique identifier of the storage device 210. Based on the identifier, the server 200 identifies encryption/decryption keys stored corresponding to the storage device identifier.

Once identified, the server 200 sends an authentication message to the personal device 112 (see FIG. 1, not shown in FIG. 2) of the user 110 (see FIG. 1, not shown in FIG. 2). The authentication message may be in any suitable format and may include instructions for the user 110 or may include any other additional details. In an example, the authentication message may be sent to the user device 112 in the form of an SMS or to an email account configured to be accessed from the user device 112.

In another implementations, the server 200 transmits one or more authentication messages to the user 110 of the storage device 210. In such implementations, the multiple messages can be sent to the personal device 110 and/or the host computer 208. In such cases, the user 110 provides an authentication response corresponding to each authentication message.

Based on the authentication message, the user 110 inputs the authentication response through the host computer 208, which then gets transmitted to the server 200 for validation. In other scenario, the authentication response may be input using the personal device 112 of the user 110 that is connected to the server 200 using any suitable protocols discussed above. In other remaining implementations, the authentication response may be received from the personal device 112 as well as from the host computer 208. Here, the server 200 receives the authentication response from the user 110 through the communication interface 206 of the server 200. In particular, the communication interface 206 is configured to receive the authentication response from the personal device 112 and/or the host computer 208.

In some examples, the authentication response may be in the form of an OTP (One Time Password), PIN, password, security questions, tokens, digital signatures, or the like. The authentication response may be numeric, alphabets or alphanumerical characters or a combination of these.

Based on the received authentication response, the server 200 validates whether the received authentication response is correct. If correct, the server 200 grants access rights to the user 110 in order to access the data stored on the storage device 210. In some implementations, the server 200 transmits encryption/decryption keys to any of the device including the personal device 112, the host computer 208 and the storage device 210. Once received, the encryption/decryption keys may be used to access the data stored on the storage device. For example, the decryption key may be used to decrypt the data stored on the storage device 210 and thus, the user can access all the stored files.

In many implementations, the server 200 performs registration of the personal device 112 with the storage device 210, or with the user 110 of the storage device 210 or a combination of these. Here, the personal device 112 is associated with the storage device 210, in particular with the identifier of the storage device 110. Such associations of the personal device may be stored with the server 200. While in other implementations, the personal device 112 may be associated with the user 110 of the storage device 210. Such personal device-to-user associations may be stored with a third party server. In particular the processor 202 of the server 200 is configured for registering an association of the personal device 112 with the storage device 210 and/or the user 110 of the storage device 210. In many embodiments, the processor 202 is further configured for generating one or more encryption keys and corresponding one or more decryption keys based on the hardware identifier. The registration process will be discussed in detail below with FIGS. 3A-3B.

In shown embodiment, the storage device 210 is a computer compatible storage device, while in other embodiments, the storage device 210 may be a mobile compatible storage device. In the latter case, the mobile may be coupled to the server 200 over the network 212 such as a telecommunication network or any other suitable network. In such implementations, the same mobile device may be used for second level authentication, the first factor protection is storage device identifier, while second factor authentication can be using the personal device of the user. The personal device may be used for performing the second level authentication via OTP, passwords, PIN or etc. In this manner, the two-factor authentication allows secured access of the storage device 210.

In an example, the storage device 210 may be in a locked state when it is first plugged into the host computer 208. To this end, the storage device 210 remains invisible to the host computer 208 and to the user 110. The content stored on the storage device 210 can only be accessed upon successful authentication using the personal device 112 of the user 110.

The above description of FIGS. 1-2 covers storage devices such as magnetic storage devices or non-volatile semiconductor memories. However, the current disclosure may be implemented for storage devices such as an optical disc without limiting the scope of the disclosure. Few non-limiting examples of the optical disc are a DVD-RAM and a CD-RW.

It may be noted that FIGS. 1 and 2 are described where the user 110 authenticates using a single personal/user device 112 (see FIG. 1). For a person skilled in the art it is understood that the user may authenticate using two or more personal devices of the user 110. This may provide an additional layer of security for protecting data.

### EXAMPLES

The present disclosure may be implemented for business environment/corporate environment, individual users or any other suitable environments.

In the context of corporate, the mobile device 112 may be associated with the storage device 104. Here, the mobile device to storage device association may be predefined and both the devices may be handed over to a user, for example, the user 110. Now when the user wishes to access the storage device 104, the server 106 checks for mobile device to storage device association and based on that the server 106 transmits an authentication message. The user provides an authentication response corresponding to the authentication message and access to the storage device 104 is granted based on the authentication message.

For individuals, the mobile device to user associations may be pre-defined. Now when the user wishes to access the storage device, the server 106 sends a query to a trusted third party which typically stores mobile device to user associations. Based on that, the server transmits an authentication message to the mobile device 112. The user provides an authentication response corresponding to the authentication message and access to the storage device 104 is granted based on the authentication message.

Exemplary Procedures for Storage Device Registration and Key Retrieval

FIGS. 3A-3D show architectural level schema used for the storage device registration procedure and key retrieval procedure. FIG. 3A shows a storage device registration procedure, according to an embodiment of the disclosure. More particularly, FIG. 3A shows an authentication service 302 that includes an access layer 306 and a key server 304 connected to each other via suitable communication protocols as mentioned above or known in the art. The access layer 306 also known as desktop layer focuses on connecting client nodes to a network. In the context of the current disclosure, the access layer 306 connects the personal device 112 to the key server 304 and/or authentication service 302. As shown, the key server 304 refers to any device that receives and serves existing cryptographic keys to users or other programs, which may be on the same network as that of the key server 304 or on any other network. In context of the disclosure, the key server 304 receives and serves cryptographic keys to the access layer 306 and/or the personal device 112 of the user 110. The authentication service 302 is an online service for authenticating the user 110 to access the data stored on the storage device 104. More particularly, the authentication service 302 facilitates validation of any authentication response—in the form OTP, PIN, password, or any other form. For a person skilled in the art, it is understood that the components authentication service 302, key server 304, and access layer 306 are known in the art, and thus, structural details may not be needed for the purpose of this disclosure. With respect to the current disclosure, functional details of these components 302, 304 and 306 will be covered.

In further detail, the authentication service 302 authenticates the user 110, the result of authentication grants/denies access to data stored on the storage device 104 to the user 110. In an example, the authentication service 302 may be termed as 2-Factor Authentication Service (2FA-service). In particular, the 2FA-service performs authentication via any registered personal device 112 that is in possession of the user 110. The personal device 112 which is used for authentication is termed as 2FA device. The 2FA-service 302 may employ any suitable authentication methodology, including, but not limited to, prompting user for PIN, Password, One Time Passwords, or any mode of authentication that are to be entered or generated via the personal device 112.

The key server 304 performs one or more functionalities related to storage devices. For example, the key server 304 performs registration of the storage devices, generation and storage of encryption keys for each such storage device. The key server 304 also handles requests to retrieve the encryption key of a registered storage device. The key server 304 further forwards information related to the storage devices to 2FA-service 302 and also enables 2FA-service to in turn register one or more personal devices of the user 110, for each such storage device.

Similar to the key server 304, the access layer 306 performs functionalities related to storage devices. For example, the access layer 306 registers the storage devices with the key server 304, retrieves encryption/decryption key combination of the storage devices, encryption and decryption of data residing in the storage devices using keys retrieved from the key server 304, granting or denying user access to the storage devices. In many embodiments, the access layer 306 provides a user-interface to the user to perform all user level functions, for example, enabling a user to input any authentication response, or accessing data stored on the storage after successful authentication.

The FIG. 3A starts with registration of the storage device 104 and the process is called Storage Device Registration Phase (SDRP, marked as 1). The registration process is initiated by the access layer 306 based on a request/consent from the user 110. To this end, the access layer 306 retrieves the storage device identifier (storage device ID) (marked as 2). Upon identification, the access layer 306 sends storage device ID to the key server 304, the storage device ID is sent for requesting registration and generation of encryption/decryption keys for the storage device 104. Here, the encryption key is used to encrypt data stored on the storage device 104 in order prevent unauthorized usage/access. The key server 304 caches the received request and in turn sends the request to the two-factor authentication service 302 to register storage device ID to any user device (for example, the device 112) that is in possession of the user 110.

Here, the registration of the user device to the storage device ID may involve one or more registration requests (marked as 3) and responses (marked as 4) among the two-factor authentication service 302, key server 304, access layer 306 and storage device 104. For example, a registration token or QR code generated by the two-factor authentication service 302 is sent to the user 110. The user 110 may be prompted to set or enter data in the user device 110 such as PIN or password (marked as 5). In this manner, the user device 112 is registered to the storage device ID to access the data stored on the storage device 104. After the successful registration (marked as 6) of the user device to storage device ID, the key server 304 generates a random key (or encryption key) (7) specific for the storage device 104 and sends it back to the access layer 306. Upon successful reception of this key, the access layer 306 performs one or more functions including encrypting files stored on the storage device 104, granting the user 110 access to the storage device 104, initiating registration of another user device to the storage device ID, granting the user 110 access to the storage device 104, or the like. In this manner, the user device 112 is registered to the storage device ID and the registered device is used for authentication so that the user 110 accesses the data stored on the storage device 104.

FIG. 3B shows a registration procedure according to another exemplary embodiment of the disclosure. In this particular embodiment, it can be considered that the encryption/decryption keys are not stored by the access layer 306 and are discarded once the storage device 104 is unplugged, powered down or a predetermined event occurs such as storage device being idle for a length of time. Subsequently, the access layer. 306 retrieves encryption/decryption keys from the key server 304. In this example, the access layer 306 may not request for generation of encryption/decryption keys but requests for the original encryption keys if generated and already preserved by key server 304. Here, the access layer 306 retrieves the storage device ID (2) and sends to the key server 304, requesting for registration. The key server 304 caches this request and in turn makes a request to two-factor authentication service to register the storage device ID to any device that is in possession of the user (example, the device 110). Here, the registration of the user device 112 to the storage device ID may involve one or more registration requests (3) and responses (4) among the two-factor authentication service 302, key server 304, access layer 306 and storage device 104. The user 110 may be prompted to set or enter data in the user device 112 such as PIN or password (5). After the successful registration (6), the user device 110 is associated to the identifier of the storage device, the key server 304 returns this registration status back to the access layer 306 (7). Here, the access layer 306 may take a number of actions including granting the user 110 access to the storage device, initiating another SDRP etc.

FIG. 3C shows a key retrieval process according to an embodiment of the disclosure. The key retrieval process is initiated by the access layer 306. The access layer 306 retrieves and transmits storage device ID (2) to the key server 304, requesting the corresponding encryption/random key to be returned. The key server 304 caches this request and sends an authentication request to service 302 to authenticate the user 110. The service 302 authenticates the user 110 via any user device (the device 110, for example), which was registered for the storage device ID during the registration process as explained above. In an example, the authentication process may involve one or more authentication requests (3) and responses (4) among the authentication service 302, key server 304, access layer 306, and storage device 104. The authentication may be in the form of push authentication or requesting an OTP (5) that the user 110 manually enters in the access layer 306. The authentication service 302 notifies the key server of successful authentication (6) of the user 110. As a result, the key server 304 retrieves the stored random key corresponding to the storage device 104 and returns it to the access layer 306 (7). The access layer 306 upon receiving the keys, performs actions such as encryption or decryption of data residing on the storage device 104 or granting the user access to the storage device 104.

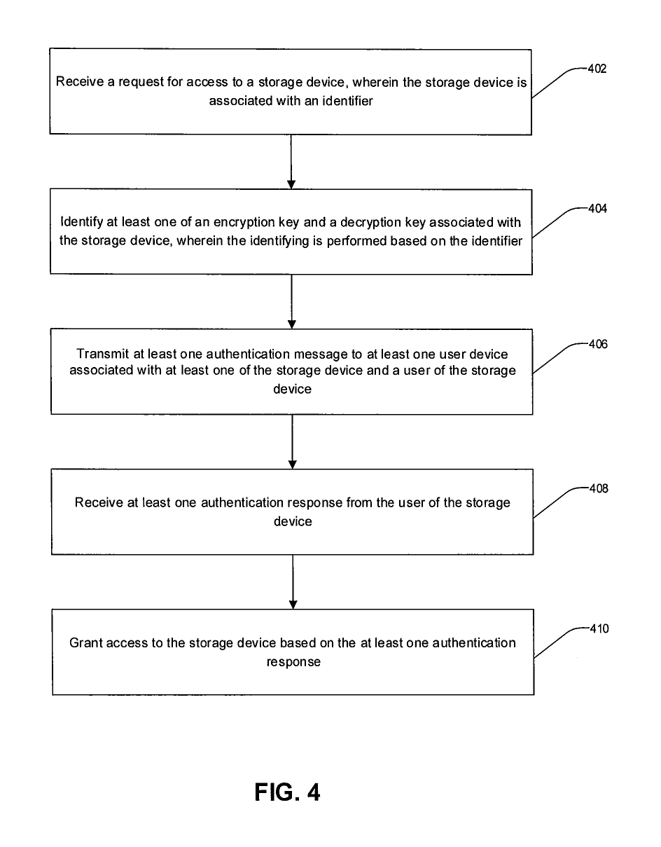

FIG. 3D shows a key retrieval procedure according to another embodiment of the disclosure. In this particular embodiment, it can be considered that the encryption/decryption keys may not be returned, thus, the data is not encrypted and the user is not given access to the storage device. In such cases, the storage device 104 becomes accessible to the user 110 based on the user authentication with the personal device 112. In this manner, the user 110 can access the unencrypted files stored on the storage device 104. Here, the access layer 306 retrieves and transmits storage device ID (2) to the key server 304. The key server 304 caches this request and directly sends an authentication request to the authentication service 302 to authenticate the user 110. The authentication service 302 authenticates the user 110 via any personal device (for example, the personal device 110) which was registered for the identifier of the storage device 104 in one or more registration procedures as discussed above in FIGS. 3A-4. The authentication process may involve one or more authentication requests (3) and responses (4) among the authentication service 302, key server 304, access layer 306, and storage device 104. To this end, the authentication service 302 sends an authentication message to the personal device 110 as a push authentication or requesting an OTP (5). The user 110 manually enters the corresponding authentication response in the access layer 306. Based on the correct response, the service 302 notifies the key server 304 of successful authentication (6) of the user 110. The key server 304 notifies the access layer 306 of the authentication result (7). After this, the access layer 306 in turn performs actions such as granting the user 110 access to the storage device 104.

Exemplary Flowchart

FIG. 4 is a method flowchart for facilitating secured access to a storage device, according to an embodiment of the disclosure. Various examples of the storage device include USB flash disk, an internal hard-drive, an external hard-drive or the like. At 402, a request to access a storage device is received, the storage device is associated with an identifier. The request includes the identifier of the storage device, the identifier may be a hardware identifier of the storage device. Based on the identifier, at 404, at least one of an encryption key and a decryption key device associated with the storage device is identified. In an embodiment, the at least one of the encryption key and the decryption key are generated when the request to access the storage device is received for the first time. The encryption and decryption keys are generated based on the identifier of the storage device.

In some embodiments, the encryption/decryption keys may be static in nature which once generated at the time of registration can be used thereafter to perform any encryption/decryption related functions on the data. While in other implementations, the encryption/decryption keys may be dynamic in nature, which gets generated each time the user plugs the storage device to the host computer and the generated keys can be used for any encryption/decryption related operations.

Upon identification of the keys, at least one authentication message is transmitted to the at least one user device associated with at least one of the storage device and a user of the storage device, at 406. In some implementations, the authentication may take place using more than one personal device of the user. In such cases, the second personal device is registered with the storage device ID.

Based on the at least one authentication message, at least one authentication response from the user of the storage device is received at 408. In some embodiments, the at least one authentication response is received from the user device. In other embodiments, the at least one authentication response is received from a host computer communicatively coupled to the storage device. In some examples, the at least one user authentication response may be in the form of at least one of a PIN, a password and a One time Password (OTP).

In embodiments, the at least one user device is associated with at least one of the storage device and the user of the storage device. Various examples of the user device include at least one of a mobile device, a tablet computer and a hardware token.

Based on the authentication response, access to the storage device is granted at 410. Granting access to the storage device allows the user to perform one or more functions of a read operation, a write operation, a delete operation, an update operation, encryption and decryption. In some embodiments, granting access to the storage device includes transmitting at least one of the encryption key and the decryption key to at least one of the storage device, a host computer communicatively coupled to the storage device and the at least one user device.

The brief Summary and Abstract sections may set forth one or more but not all example embodiments and thus are not intended to limit the scope of the present disclosure and the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described example embodiments, but should be defined only in accordance with the following claims and their equivalents.

1. A method of facilitating secured access to a storage device, the method comprising:
a. receiving a request for access to the storage device, wherein the storage device is associated with an identifier;
b. identifying at least one of an encryption key and a decryption key associated with the storage device, wherein the identifying is performed based on the identifier;
c. transmitting at least one authentication message to at least one user device associated with at least one of the storage device and a user of the storage device;
d. receiving at least one authentication response from the user of the storage device; and
e. granting access to the storage device based on the at least one authentication response.

2. The method of claim 1, wherein the request comprises the identifier.

3. The method of claim 1, wherein receiving the at least one authentication response from the user comprises receiving the at least one authentication response from the at least one user device.

4. The method of claim 1, wherein receiving the at least one authentication response from the user comprises receiving the at least one authentication response from a host computer communicatively coupled to the storage device.

5. The method of claim 1, wherein granting access to the storage device comprises allowing the user to perform at least one of a read operation, a write operation, a delete operation, an update operation, encryption and decryption.

6. The method of claim 1, wherein granting access to the storage device comprises transmitting at least one of the encryption key and the decryption key to at least one of the storage device, a host computer communicatively coupled to the storage device and the at least one user device.

7. The method of claim 1 further comprising registering an association of the at least one user device with at least one of the storage device and the user of the storage device.

8. The method of claim 1, wherein the at least one user device comprises at least one of a mobile device, a tablet computer and a hardware token.

9. The method of claim 1, wherein the at least one user authentication response comprises at least one of a PIN, a password and a One time Password (OTP).

10. The method of claim 1, wherein the storage device comprises at least one of a USB flash disk, an internal hard-drive and an external hard-drive.

11. The method of claim 1 further comprising generating at least one of the encryption key and the decryption based on the identifier.

12. The method of claim 1, wherein the identifier is a hardware identifier.

13. A server for facilitating secured access to a storage device communicatively coupled to a client computer, wherein the client computer is communicatively coupled to the server over a network, the server comprising a communication interface, a processor and a memory communicatively coupled to the processor, wherein the memory is configured to store program code which when executed by the processor causes the server to:
a. receive a request for access to the storage device, wherein the request comprises a hardware identifier associated with the storage device;
b. identify at least one of an encryption key and a decryption key associated with the storage device based on the hardware identifier;
c. transmit an authentication message to at least one user device associated with at least one of the storage device and a user of the storage device;
d. receive an authentication response from the user; and
e. transmit at least one of the encryption key and the decryption key to at least one of the at least one user device and the client computer based on the authentication response.

14. The server of claim 13, wherein the communication interface is configured to receive the at least one authentication response from the at least one user device.

15. The server of claim 13, wherein the communication interface is configured to receive the at least one authentication response from the client computer.

16. The server of claim 13, wherein the processor is further configured for registering an association of the at least one user device with at least one of the storage device and the user of the storage device.

17. The server of claim 13, wherein the at least one user device comprises at least one of a mobile device, a tablet computer and a hardware token.

18. The server of claim 13, wherein the at least one user authentication response comprises at least one of a PIN, a password and a One time Password (OTP).

19. The server of claim 13, wherein the storage device comprises at least one of a USB flash disk, an internal hard-drive and an external hard-drive.

20. The server of claim 13, wherein the processor is further configured to for generating at least one of the encryption key and the decryption based on the hardware identifier.
